(19) United States
(12) Patent Application Publication
(10) Pub. No.: US 2004/0154643 A1
(43) Pub. Date: Aug. 12, 2004

(54) Method of controlling combination washer drier

(75) Inventors: Kwang Soo Kim, Changwon-si (KR); Jae Mun Kim, Jinhae-si (KR); Sam Je Park, Gimhae-si (KR); Hyun Jae Lee, Jinju-si (KR)

Correspondence Address: MCKENNA LONG & ALDRIDGE LLP, 1900 K STREET, NW, WASHINGTON, DC, 20006, US

(73) Assignee: LG ELECTRONICS INC. WASHING MA

(21) Appl. No.: 10/720,683

(22) Filed: Nov. 25, 2003

(30) Foreign Application Priority Data
Nov. 26, 2002 (KR) P2002-0074049

(51) Int. Cl. B08B 7/04

(52) U.S. Cl. 134/18; 8/158

(57) ABSTRACT

A method of controlling a combined washing and drying machine is provided, which decreases the time required for completing the overall process from washing to drying. The method includes steps of inputting an operational command; performing washing and rinsing steps according to the operational command; simultaneously performing a dewatering step and a first drying step after completion of the watering and rinsing steps; and performing a second drying step after completion of the dewatering step. The first drying step may include the driving of a pump, a fan, a heater, and a drum motor, while the second drying step may include the driving of a supply valve in addition to the pump, fan, heater, and drum motor.

This application claims the benefit of Korean Application No. 10-2002-0074049 filed on Nov. 26, 2002, which is hereby incorporated by reference.

### BACKGROUND OF THE INVENTION

1. Field of the Invention

The present invention relates to a combination washer drier, and more particularly, to a method of controlling a combined washing and drying machine.

2. Discussion of the Related Art

Generally speaking, washing machines include a top-loading pulsator type and a front-loading drum type, each having a tub into which laundry is loaded. Such a washing machine may be combined with a drier, so that a drying course is automatically performed on the laundry following a wash course. FIG. 1 illustrates a general combination washer drier.

The combination washer drier of FIG. 1 is comprised of a body 1; a tub 2 for holding water; a drum 3, rotated by a drum motor 10 via a belt 11 to perform washing and drying, for holding laundry; a pump 4 for draining water; a fan 5 for circulating air to dry the laundry in the drum; a heater 6 for heating the air circulated by the fan; a supply valve 7, installed in an air circulation passage, to supply water for producing condensed water from the drying air passing through the drum; and a pair of temperature sensors 8 and 9, installed at the air circulation passage and the tub, respectively, for monitoring a drying state. The above-described apparatus is controlled by a microcomputer (not shown).

FIG. 2 illustrates a combination washer drier controlling method according to a related art, whereby a washing and drying cycle is executed for laundry that has been placed in the drum 3, for example, by a user pressing a predetermined operational key. The microcomputer detects a laundry amount, performs a water supply operation according to the detected laundry amount, which is followed by a draining of the water, and drives the drum motor 10 to perform a washing step (S21). A rinsing step (S22) is then performed through a similar operation of supplying water and driving the drum motor 10 to drain the water. Thereafter, a dewatering step (S23) is performed by driving the pump 4 and drum motor 10. In doing so, the drum 3 is rotated at a predetermined rotational speed for a time set manually by the user or a time set automatically according to the laundry amount.

Drying begins upon completion of the dewatering step of the wash cycle. In doing so, the fan 5, heater 6, supply valve 7 (held open), pump 4, and drum motor 10 are driven/actuated (S24).

In performing the above drying step, the drum motor 10 starts to rotate the drum 3 as soon as the fan 5 and heater 6 begin to operate, so that high-temperature air passes over the laundry in the drum and is re-circulated by the fan, to remove the water contents of the laundry. A completed drying state is determined by the microcomputer, which reads measurement values of the temperature sensors 8 and 9. While the drying proceeds, the microcomputer drives (opens) the supply valve 7 to supply the air circulation passage with water. The water supplied from the supply valve 7 cools the humid air, i.e., air containing water, to produce condensed water, which is discharged via a condensation pipe. Hence, only air which has had its water content removed, i.e., dry air, circulates through the fan 5 and the heater 6 to be heated.

The above-described combination washer drier according to the related art requires a long time to complete the drying step, which stresses the various loads and consumes excessive power. A method is needed for shortening the overall process.

### SUMMARY OF THE INVENTION

Accordingly, the present invention is directed to a method of controlling a combined washing and drying machine that substantially obviates one or more of the problems due to limitations and disadvantages of the related art.

An object of the present invention, which has been devised to solve the foregoing problem, lies in providing a method of controlling a combination washer drier, which decreases the time for completing the overall process from washing to drying.

It is another object of the present invention to provide a method of controlling a combination washer drier, which reduces the stress of the various loads of the apparatus.

It is another object of the present invention to provide a method of controlling a combination washer drier, which reduces the power consumption of the apparatus.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a method of controlling a combination washer drier. The method comprises steps of inputting an operational command; performing washing and rinsing steps according to the operational command; simultaneously performing a dewatering step and a first drying step after completion of the watering and rinsing steps; and performing a second drying step after completion of the dewatering step. Preferably, a fan, a heater, and a drum motor are driven during the first drying step, and the pump, fan, heater, drum motor, and a supply valve are driven during the second drying step.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a general combination washer drier;

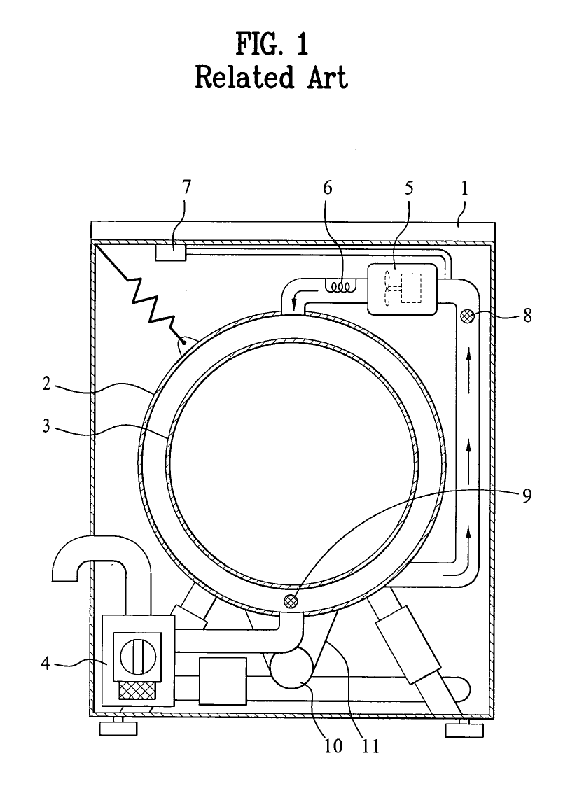

FIG. 2 is a flowchart of a combination washer drier controlling method according to a related art; and

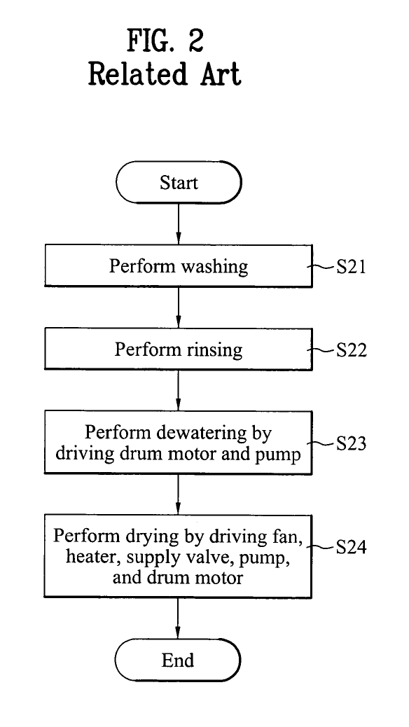

FIG. 3 is a flowchart of a combination washer drier controlling method according to the present invention.

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

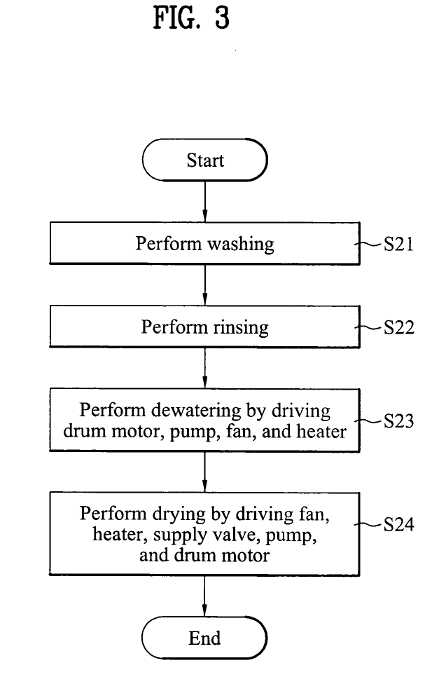

Referring to FIG. 3, illustrating a combination washer drier controlling method according to the present invention, whereby a washing and drying cycle is executed for laundry that has been placed in the drum 3, for example, by a user pressing a predetermined operational key. The microcomputer detects a laundry amount, performs a water supply operation according to the detected laundry amount, which is followed by a draining of the water, and drives the drum motor 10 to perform a washing step (S31). A rinsing step (S32) is then performed through a similar operation of supplying water and driving the drum motor 10 to drain the water.

Dewatering is then performed by driving the pump 4, fan 5, heater 6, and drum motor 10 (S33). In doing so, the drum 3 is rotated at a predetermined rotational speed for a time set manually by the user or a time set automatically according to the laundry amount. Thus, the dewatering step includes a pre-drying of the laundry prior to the drying step, by way of including the driving of the fan 4 and heater 6 during dewatering. Here, the supply valve 7 is not driven (left closed) because the production of condensed water from the circulating air is ineffectual due to the excessive water content of the laundry during dewatering.

Drying continues upon completion of the dewatering step of the wash cycle. In doing so, the pump 4, fan 5, heater 6, drum motor 10, and supply valve 7 are driven/actuated (S34).

In performing the above drying step, the drum motor 10 starts to rotate the drum 3 as soon as the fan 5 and heater 6 begin to operate, so that high-temperature air passes over the laundry in the drum and is re-circulated by the fan, to remove the water contents of the laundry. A completed drying state is determined by the microcomputer, which reads measurement values of the temperature sensors 8 and 9. While the drying proceeds, the microcomputer drives the supply valve 7 to supply the air circulation passage with water. Water supplied from the supply valve 7 condenses the water content of the humid air, and the resulting water is discharged via a condensation pipe. Hence, only air which has had its water content removed, i.e., dry air, circulates through the fan 5 and the heater 6 to be heated.

By adopting the method of the present invention, the drying procedure is quickly completed more quickly than in the method of the related art, due to the pre-drying of the dewatering step. Accordingly, a combination washer drier adopting the method of the present invention requires less time to complete the overall process from washing to drying, thereby reducing the stress of the various loads and reducing power consumption. Moreover, since the present invention reduces the time of the overall process by reducing the time of the drying procedure through a pre-drying during dewatering, the present invention is not limited to the air circulation-type or condensation-type washer drier, but is applicable to any washing machine performing a drying procedure after dewatering.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A method of controlling a combination washer drier, comprising steps of:
inputting an operational command;
performing washing and rinsing steps according to the operational command;
simultaneously performing a dewatering step and a first drying step after completion of the watering and rinsing steps; and
performing a second drying step after completion of the dewatering step.

2. The method as claimed in claim 1, wherein a pump, a fan, a heater, and a drum motor are driven during the first drying step.

3. The method as claimed in claim 1, wherein a pump, a fan, a heater, a drum motor, and a supply valve are driven during the second drying step.
